(19) United States
(12) Patent Application Publication
(10) Pub. No.: US 2014/0278844 A1
(43) Pub. Date: Sep. 18, 2014

(54) SYSTEMS AND METHODS RELATING TO OFFLINE GAMEPLAY

(71) Applicant: Zynga Inc., San Francisco, CA (US)

(72) Inventor: Nishchaie Khanna, San Mateo, CA (US)

(73) Assignee: Zynga Inc., San Francisco, CA (US)

(21) Appl. No.: 13/829,011

(22) Filed: Mar. 14, 2013

(51) Int. Cl. A63F 13/12

(52) U.S. Cl. CPC A63F 13/12; G06Q 30/0241
USPC 705/14.4; 463/42

(57) ABSTRACT

A system, machine-readable storage medium storing at least one program, and a computer-implemented method for allowing offline gameplay is provided. A client device may receive a request to access a game through a game user interface. If the client device is offline, the client device may generate an advertisement using one or more cached objects stored on the client device and provide the advertisement in the game user interface. Additionally, when a request to purchase a game asset of the game is received while the client device is offline, a reliability score indicating a likelihood of receiving payment for the game asset may be used to determine whether to provide the game asset in the game user interface while the client device is offline.

### TECHNICAL FIELD

The present disclosure relates to games and applications in general and in particular to computer-implemented games. In an example embodiment, a player may be given the ability to play a game while the player's device is offline.

### BACKGROUND

The popularity of computer-implemented games is ever-growing, and this popularity has been recognized by many entities acquiring value through the popularity of these games. For example, advertising through the user interfaces for these games has become an effective way to market products and services to consumers playing these games. Additionally, the sale of in-game assets has provided valuable revenue for such entities.

While these games may be useful platforms for generating revenue, the generation of revenue may be halted when a player plays a game offline.

### BRIEF DESCRIPTION OF THE DRAWINGS

The present disclosure is illustrated by way of example, and not limitation, in the figures of the accompanying drawings, in which like reference numerals indicate similar elements unless otherwise indicated. In the drawings,

FIG. 1 is a schematic diagram showing an example of a system, according to some embodiments;

FIG. 2 is a schematic diagram showing an example of a social network within a social graph, according to some embodiments;

FIG. 3 is a block diagram showing example components of a game networking system, according to some embodiments;

FIG. 4 is a block diagram showing example components of a client device, according to some embodiments;

FIG. 5 is a flowchart showing an example method of offline advertisement generation, according to some embodiments;

FIG. 6 is an interface diagram illustrating an example game user interface to provide an advertisement generated while offline, according to some embodiments;

FIG. 7 is a flowchart showing an example method of allowing offline game asset purchases, according to some embodiments;

FIG. 8 is an interface diagram illustrating an example game user interface to allow game asset purchases while offline, according to some embodiments;

FIG. 9 is a diagrammatic representation of an example data flow between example components of the example system of FIG. 1, according to some embodiments;

FIG. 10 is a schematic diagram showing an example network environment, in which various example embodiments may operate, according to some embodiments; and

FIG. 11 is a block diagram illustrating an example computing system architecture, which may be used to implement one or more of the methodologies described herein, according to some embodiments.

### DESCRIPTION OF EXAMPLE EMBODIMENTS

### Overview

Players of one or more computer-implemented virtual games may be provided with the ability to play a game while offline. A client device of a player may have a game application associated with one or more computer-implemented games. When the client device is able to access a game server associated with a game, the player may have access to game features such as the ability to purchase game assets, the ability to receive advertisements, and the like, where the game features may be provided over a network from the game server to the client device. When the client device is unable to access the game server (e.g., offline), the player may still be able to access game features such as advertisements and game assets available for purchase. When the client device is offline, advertisements may be generated on-the-fly on a game user interface associated with the game application on the client device. Additionally, game assets may be purchased through the game user interface while the client device is offline.

For example, the game application may store cached objects that may be used to generate an advertisement while the client device is offline. The game application may also store any relevant information about the player that may be used in the generation of the advertisement. The game application may receive and store the cached objects and the user information from the game server while the client device is able to communicate with the game server. When the client device is offline, advertisements may be generated on-the-fly by the game application using the cached objects and the user information. For example, if the user information indicates that the player associated with the game application is likely to click on an advertisement containing a video, the game application may search the stored cached objects to find a video object and generate an advertisement using the video object.

In another example, the game application may store a reliability score related to the player associated with the game application. The reliability score may indicate a likelihood that a player will pay for the purchase of a game asset if the game asset is provided to the player before payment (e.g., while offline). The game application may receive and store the reliability score from the game server while the client device is able to communicate with the game server. When the client device is offline, the player may attempt to purchase a game asset, and the game application may access the stored reliability score to determine whether the purchase of the game asset should be allowed. For example, if the stored reliability score meets or exceeds a minimum reliability score, the game application may provide the game asset to the player while the player is offline. When the client device subsequently comes online, the player's game account managed by the game server may be updated to reflect the game asset purchased. In some embodiments, the player may be asked to provide payment for the game asset when the client device comes online. In some embodiments, when the client device comes online, the player's game account may automatically be adjusted to reflect the game asset purchased offline. If the reliability score does not meet or exceed the minimum reliability score, the player may be unable to purchase the game asset while the client device is offline.

### Example System

FIG. 1 is a schematic diagram showing an example of a system 100 for implementing various example embodiments. In some embodiments, the system 100 comprises a player 102, a client device 104, a network 106, a social networking system 108.1, and a game networking system 108.2. The components of the system 100 may be connected directly or over a network 106, which may be any suitable network. In various embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The client device 104 may be any suitable computing device (e.g., devices 104.1-104.n), such as a smart phone 104.1, a personal digital assistant (PDA) 104.2, a mobile phone 104.3, a personal computer 104.n, a laptop, a computing tablet, or any other device suitable for playing a virtual game. The client device 104 may access the social networking system 108.1 or the game networking system 108.2 directly, via the network 106, or via a third-party system. For example, the client device 104 may access the game networking system 108.2 via the social networking system 108.1.

The social networking system 108.1 may include a network-addressable computing system that can host one or more social graphs 200 (see for example FIG. 2), and may be accessed by the other components of system 100 either directly or via the network 106. The social networking system 108.1 may generate, store, receive, and transmit social networking data. Moreover, the game networking system 108.2 may include a network-addressable computing system (or systems) that can host one or more virtual games, for example, online games. The game networking system 108.2 may generate, store, receive, and transmit game-related data, such as, for example, game account data, game input, game state data, and game displays. The game networking system 108.2 may be accessed by the other components of system 100 either directly or via the network 106. The player 102 may use the client device 104 to access, send data to, and receive data from the social networking system 108.1 and/or the game networking system 108.2.

Although FIG. 1 illustrates a particular example of the arrangement of the player 102, the client device 104, the social networking system 108.1, the game networking system 108.2, and the network 106, this disclosure includes any suitable arrangement or configuration of the player 102, the client device 104, the social networking system 108.1, the game networking system 108.2, and the network 106.

FIG. 2 is a schematic diagram showing an example of a social network within a social graph 200. The social graph 200 is shown by way of example to include an out-of-game social network 250, and an in-game social network 260. Moreover, in-game social network 260 may include one or more players that are friends with Player 201 (e.g., Friend 231), and may include one or more other players that are not friends with Player 201. The social graph 200 may correspond to the various players associated with one or more virtual games.

### Example Offline Gameplay

It is to be appreciated that the virtual game board for a game may be presented to a player in a variety of manners. In some embodiments, the game board for the game may be displayed within a game user interface on a client device of a player. The game board may allow a player to play the game. When the client device is in communication with a game server (e.g., via network 106 of FIG. 1), the player may be able to access game content available from the game server (e.g., advertisements, game assets available for purchase, etc.). When the client device is unable to communicate with the game server (e.g., offline), the player may still have the ability to access game content. For example, game content that may typically be provided to a client device from a game server may be presented to a player even if the client device is offline. For example, advertisements may be generated and presented to a player on-the-fly when the client device is offline, where the advertisements may be specifically targeted to the player. In another example, a game asset available for purchase may be provided to a player before the player pays for the game asset if the player is associated with a reliability score that is greater than or equal to a minimum reliability score.

FIG. 3 is a block diagram showing example components of a game networking system 108.2, as shown in FIG. 1. The game networking system 108.2 may include a game engine 305, a graphical display output interface module 310, a user input interface module 315, an advertisement generation module 320, a user reliability module 325, and a payment module 330. The components of the game networking system 108.2 may allow a player to play a game, view advertisements while offline, purchase game assets while offline, and the like.

The game engine 305 may be a hardware-implemented module which may manage and control any aspects of a game based on rules of the game, including how a game is played, players' actions and responses to players' actions, and the like. The game engine 305 may be configured to generate a game instance of a game of a player and may determine the progression of a game based on user inputs and rules of the game.

The graphical display output interface module 310 may be a hardware-implemented module that may manage and control information or data that is provided to client systems for display on a client device. For example, the graphical display output module 310 may be configured to provide display data associated with displaying a game instance of a game, displaying a game user interface associated with one or more games, and the like.

The user input interface module 315 may be a hardware-implemented module which may receive user inputs for processing by the game engine 305 based on rules of the game. For example, the user input interface module 315 may receive user inputs indicating functions, such as a game move or game content provided by a player, requests to access content, and the like.

The advertisement generation module 320 may be a hardware-implemented module which may generate, store, and manage advertisement objects and user information and may generate advertisements using the advertisement objects and the user information. Advertisement objects may be any components that may be used in the generation of an advertisement, such as text, video, graphics, and the like. One or more advertisements objects may be combined in any suitable manner to generate an advertisement based on user information associated with a player. User information may be any relevant information relating to a specific player that may be used to target an advertisement to the specific player, such as demographic information, information relating to the history of the player's behavior (information about aesthetic features that have been effective in engaging the player, information about which advertisements the player has previously accessed, etc.), any statistics relating to the behavior of other players (e.g., other players similar to the specific player), and the like.

The advertisement generation module 320 may update the advertisement objects periodically or as additional and/or revised advertisement objects become available (e.g., from an entity wishing to advertise via the game user interface on the client device). The advertisement generation module 320 may also update the user information periodically or as additional and/or revised user information becomes available (e.g., when additional user information is obtained). The advertisement generation module 320 may send the advertisement objects and the user information to the client device through the game user interface when the client device is able to communicate with the game networking system 108.2, and the client device may store the advertisement objects and the user information for use in generating advertisements when the client device is offline. In some embodiments, the advertisement generation module 320 may send the advertisement objects and user information, or updates to the advertisement objects and user information, periodically (e.g., on a daily basis) when the client device is able to communicate with the game networking system 108.2. In some embodiments, the advertisement generation module 320 may send the updates as updates become available.

The user reliability module 325 may be a hardware-implemented module that may generate, store, and manage reliability scores for players that may indicate the likelihood that each player will pay for the purchase of a game asset if the game asset is provided to the player before payment (e.g., while offline). For example, the reliability score may indicate that a player may purchase game assets up to a particular sum of money without having to pay for the game assets before receiving the game assets. The user reliability module 325 may calculate a reliability score associated with a player based on any relevant information indicating the player's payment reliability, such as the level of engagement of the player, the player's current level in the game, the number of opponents a player has within the game, the player's history of reliability, the number of people in the player's social network, the amount of money the player typically spends in a game, the player's history of defaulting on payment, the player's reliability history in other games associated with the game networking system 108.2, and the like. For example, a reliability score for a player may be lower if the player has been known to default on payment in the past. In some embodiments, any previous payment default may result the player being unable to access game assets before payment is received. While the user reliability module 325 is described herein as calculating a reliability score, one of ordinary skill in the art will recognize that any suitable manner of determining and indicating the payment reliability of the user may be used.

The user reliability module 325 may update a player's reliability score periodically or as additional information about the user becomes available (e.g., when the player defaults on a payment). The user reliability module 325 may send the reliability score to the client device through the game user interface when the client device is able to communicate with the game networking system 108.2, and the client device may store the reliability score for use in determining whether to allow a player to purchase a particular asset while the client device is offline. In some embodiments, the user reliability module 325 may send the reliability score, or updates to the reliability score, periodically (e.g., on a daily basis) when the client device is able to communicate with the game networking system 108.2. In some embodiments, the user reliability module 325 may send the updates as updates become available.

The payment module 330 may be a hardware-implemented module that may manage and process payments made for purchases associated with a game of the game networking system 108.2. The payment module 330 may manage a payment account for a player, process payments received from a player, manage funds within the account of the player, and the like. For example, when a player attempts to purchase a game asset while the player's client device is in communication with the game networking system 108.2, the payment module 330 may receive payment information (e.g., credit card or bank information) from the player via the game user interface on the client device of the player and process the payment in exchange for providing the game asset. In some embodiments, the payment module 330 may store payment information (e.g., credit card or bank information) that may automatically be used for game asset purchases.

FIG. 4 is a block diagram showing example components of a client device 104, as shown in FIG. 1. One or more of the components shown in FIG. 4 may be part of an application of the computer-implemented game. The client device 104 may include a game engine 405, a display module 410, an input module 415, an advertisement generation module 420, a user reliability module 425, a payment module 330, and a network detection module 435. The components of the client device 104 may allow a player to play a game through a game user interface on the client device, view advertisements generated while offline, purchase game assets while offline, and the like.

The game engine 405 may be a hardware-implemented module that may communicate with the game engine 305 of FIG. 3 to facilitate management and control of any aspects of a game based on rules of the game. The game engine 405 may receive a game instance of a game from the game engine 305 of FIG. 3 to be displayed to the player in the game user interface of the client device 104. The game engine 405 may also facilitate gameplay while the client device 104 is offline.

The display module 410 may be a hardware-implemented module that may manage and control information or data that is received from the graphical display output interface module 310 of FIG. 3 for display through the game user interface on the client device 104. For example, the display module 410 may receive display data associated with displaying a game instance of a game, displaying a game user interface associated with one or more games. The display module 410 may use the display data to display game elements accordingly. The display module 410 may also display game elements while the client device 104 is offline.

The input module 415 may be a hardware-implemented module that may receive user inputs from a player (e.g., keyboard inputs, touch inputs, mouse inputs, etc.) and, in some embodiments, may send data corresponding to the user inputs to the user input interface module 315 of FIG. 3. For example, the input module 415 may receive user inputs indicating functions, such as a game move or game content provided by a player, requests to access content, and the like. When the client device 104 is offline, the input module 415 may receive user inputs for processing by the game engine 405.

The advertisement generation module 420 may be a hardware-implemented module that may store and manage advertisement objects and user information, as well as any updates to the advertisement objects and user information, received from the advertisement generation module 320 of FIG. 3. The advertisement generation module 420 may also use the stored or cached advertisement objects and user information to dynamically generate an unlimited number of advertisements on-the-fly. For example, while the client device 104 is in communication with the game networking system 108.2 of FIG. 3, the advertisement generation module 420 may receive and store advertisement objects and user information, as well as any updates to the advertisement objects and user information, from the advertisement generation module 320 of FIG. 3. When the client device 104 is offline, the advertisement generation module 420 may use the stored advertisement objects to generate an advertisement based on the user information. The advertisement generation module 420 may use any suitable number and combination of advertisement objects stored by the advertisement generation module 420 to generate an advertisement in accordance with the user information.

The user reliability module 425 may be a hardware-implemented module that may receive, store, manage, and update a reliability score received from the user reliability module 325 of FIG. 3. The user reliability module 425 may determine whether the stored reliability score is greater than or equal to a minimum reliability score and may provide a game asset to a player if the reliability score of the player indicates that the player is likely to pay for the game asset once the client device comes online. The reliability score may be updated from the game networking system 108.2 in any manner (e.g., periodically, when update available, etc.).

The payment module 430 may be a hardware-implemented module that may manage and process payments or pending payments for purchases associated with the game networking system 108.2. The payment module 430 may track payments pending due to offline activity, manage any credit available on a player's account, notify the player of a pending payment, and the like. The payment module 430 may receive any relevant payment information, and updates to the payment information, from the payment module 330 of FIG. 3 (e.g., credit available in player's account). The payment information may be updated from the payment module 330 of FIG. 3 in any manner (e.g., periodically, when updated payment information becomes available, etc.). When a player makes a payment (e.g., pending payment paid using credit available on the player's account), the payment information in the payment module 430 may be updated accordingly. Additionally, the payment module 430 may send updated payment information to the payment module 330 of FIG. 3, which may also be updated accordingly.

In some embodiments, when a pending payment has been paid by the player, the payment module 430 may notify the user reliability module 425 that a pending payment was cleared, and the user reliability module 425 may update the player's reliability score accordingly. The updated reliability score may be sent from the client device 104 to the game networking system 108.2 such that the reliability score managed by the user reliability module 325 may also be updated accordingly.

The network detection module 435 may be a hardware-implemented module that may detect whether the client device is connected to a network (e.g., network 106 of FIG. 1). The network detection module 435 may detected that the client device is either able or unable to access the game networking system 108.2.

FIG. 5 is a flowchart showing an example method 500 of offline advertisement generation. The method 500 may be performed by the client device 104 shown in FIG. 4 and provides an example of generating an advertisement while the client device 104 is offline.

In operation 502, the input module 415 may receive a request to access a game through a game user interface on a client device. The request may be received through a user input provided by a player (e.g., touch screen, keyboard, mouse, etc.).

In operation 504, the network detection module 435 may identify that the client device is unable to communicate with a game server associated with the game. For example, the network detection module 435 may detect that the client device is not connected to a communication network (e.g., network 106 of FIG. 1).

In operation 506, in response to identifying that the client device is unable to communicate with the game server, the advertisement generation module 420 may generate an advertisement using one or more cached objects stored on the client device. As described above, the cached objects may be received from the game server when the client device was previously in communication with the game server and stored on the client device. The advertisement may use the one or more cached objects to generate an advertisement in accordance with user information stored on the client device. For example, if the user information indicates that the player is male, the advertisement that is generated may use cached objects that are designed to be targeted toward the male demographic. In another example, if the user information indicates that the player is engaged by advertisements with bright colors, the advertisement that is generated may use cached objects with bright colors.

In operation 508, the display module 410 may provide access to the game including providing the advertisement in the game user interface. In some embodiments, any interactions a player may have with the provided advertisement may be recorded and added to the user information stored on the client device. When the client device comes online, the user information on the game networking system 108.2 may be updated accordingly.

FIG. 6 is an interface diagram illustrating an example game user interface 600 to provide an advertisement generated while offline. The game user interface 600 may display an advertisement generated using cached objects, such as an advertisement title 602, a graphic 604, text 606, and a video 608. The cached objects used to generate the advertisement may be selected based on the user information associated with the player of the game user interface 600.

FIG. 7 is a flowchart showing an example method 700 of allowing offline game asset purchases. The method 700 may be performed by the client device 104 shown in FIG. 4 and provides an example of providing game assets available for purchase while the client device 104 is offline.

In operation 702, the input module 415 may receive a request to purchase a game asset of a game through a game user interface on the client device. The request may be received through a user input provided by a player (e.g., touch screen, keyboard, mouse, etc.).

In operation 704, the network detection module 435 may identify that the client device is unable to communicate with a game server associated with the game. For example, the network detection module 435 may detect that the client device is not connected to a communication network (e.g., network 106 of FIG. 1).

In operation 706, in response to identifying that the client device is unable to communicate with the game server, the user reliability module 425 may access a reliability score stored on the client device and received from the game server when the client device was previously in communication with the game server. As described above, the reliability score may indicate a likelihood of receiving a payment in exchange for the game asset requested. The reliability score may be calculated based on any relevant information indicating the reliability of the player of the game user interface (e.g., an amount of game assets the player has previously purchased, a number of other players who communicate with the player, history of player activity, the frequency at which the player plays the game, the number of times the player has defaulted on payment, etc.). In some embodiments, if the player has defaulted on a past payment, the user reliability module 425 may not provide the game asset to the player.

In operation 708, the display module 410 may provide the game asset in the game user interface if the reliability score is greater than or equal to a minimum reliability score.

FIG. 8 is an interface diagram illustrating an example game user interface 800 to allow game asset purchases while offline. When a player plays a game offline, the game user interface 800 may provide game assets available for purchase by the player. For example, the game user interface 800 may allow a player to purchase the game asset 802 for a particular amount of money. If the player clicks on the game asset 802, the client device may first determine whether the reliability score of the player is greater than or at least equal to a minimum reliability score. If the player's reliability score indicates that the player is likely to pay for the purchase of the game asset 802, the client device may provide the game asset 802 to the player before receiving payment from the player.

In some embodiments, the player's reliability score may also indicate a maximum value that the player may spend on game assets, and the player may not be allowed exceed the maximum value when purchasing game assets offline. In some embodiments, the maximum value may be increased as the player's reliability score increases.

### Storing Game-Related Data

A database may store any data relating to game play within a game networking system 108.2. The database may include database tables for storing a player game state that may include information about the player's virtual game board, the player's character, or other game-related information. For example, player game state may include virtual objects owned or used by the player, placement positions for virtual structural objects in the player's virtual game board, and the like. Player game state may also include in-game obstacles of tasks for the player (e.g., new obstacles, current obstacles, completed obstacles, etc.), the player's character attributes (e.g., character health, character energy, amount of coins, amount of cash or virtual currency, etc.), and the like.

The database may also include database tables for storing a player profile that may include user-provided player information that is gathered from the player, the player's client device, or an affiliate social network. The user-provided player information may include the player's demographic information, the player's location information (e.g., a historical record of the player's location during game play as determined via a GPS-enabled device or the internet protocol (IP) address for the player's client device), the player's localization information (e.g., a list of languages chosen by the player), the types of games played by the player, and the like.

In some example embodiments, the player profile may also include derived player information that may be determined from other information stored in the database. The derived player information may include information that indicates the player's level of engagement with the virtual game, the player's friend preferences, the player's reputation, the player's pattern of game-play, and the like. For example, the game networking system 108.2 may determine the player's friend preferences based on player attributes that the player's first-degree friends have in common, and may store these player attributes as friend preferences in the player profile. Furthermore, the game networking system 108.2 may determine reputation-related information for the player based on user-generated content (UGC) from the player or the player's N^{th} degree friends (e.g., in-game messages or social network messages), and may store this reputation-related information in the player profile. The derived player information may also include information that indicates the player's character temperament during game play, anthropological measures for the player (e.g., tendency to like violent games), and the like.

In some example embodiments, the player's level of engagement may be indicated from the player's performance within the virtual game. For example, the player's level of engagement may be determined based on one or more of the following: a play frequency for the virtual game or for a collection of virtual games; an interaction frequency with other players of the virtual game; a response time for responding to in-game actions from other players of the virtual game; and the like.

In some example embodiments, the player's level of engagement may include a likelihood value indicating a likelihood that the player may perform a desired action. For example, the player's level of engagement may indicate a likelihood that the player may choose a particular environment, or may complete a new challenge within a determinable period of time from when it is first presented to him.

In some example embodiments, the player's level of engagement may include a likelihood that the player may be a leading player of the virtual game (a likelihood to lead). The game networking system 108.2 may determine the player's likelihood to lead value based on information from other players that interact with this player. For example, the game networking system 108.2 may determine the player's likelihood to lead value by measuring the other players' satisfaction in the virtual game, measuring their satisfaction from their interaction with the player, measuring the game-play frequency for the other players in relation to their interaction frequency with the player (e.g., the ability for the player to retain others), and/or the like.

The game networking system 108.2 may also determine the player's likelihood to lead value based on information about the player's interactions with others and the outcome of these interactions. For example, the game networking system 108.2 may determine the player's likelihood to lead value by measuring the player's amount of interaction with other players (e.g., as measured by a number of challenges that the player cooperates with others, and/or an elapsed time duration related thereto), the player's amount of communication with other players, the tone of the communication sent or received by the player, and/or the like. Moreover, the game networking system 108.2 may determine the player's likelihood to lead value based on determining a likelihood for the other players to perform a certain action in response to interacting or communicating with the player and/or the player's virtual environment.

### Example Game Systems, Social Networks, and Social Graphs

In a multiplayer game, players control player characters (PCs), a game engine controls non-player characters (NPCs), and the game engine also manages player character state and tracks states for currently active (e.g., online) players and currently inactive (e.g., offline) players. A player character may have a set of attributes and a set of friends associated with the player character. As used herein, the terms “state” and “attribute” can be used interchangeably to refer to any in-game characteristic of a player character, such as location, assets, levels, condition, health, status, inventory, skill set, name, orientation, affiliation, specialty, and so on. The game engine may use a player character state to determine the outcome of a game event, sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights and/or benefits or the obtaining of some assets (e.g., health, money, strength, inventory, land, etc.). A game engine may determine the outcome of a game event according to game rules (e.g., “a character with less than 5 health points will be prevented from initiating an attack”), based on a character's state and possibly also interactions of other player characters and a random calculation. Moreover, an engagement may include simple tasks (e.g., cross the river, shoot at an opponent), complex tasks (e.g., win a battle, unlock a puzzle, build a factory, rob a liquor store), or other events.

In a game system according to aspects of the present disclosure, in determining the outcome of a game event in a game being played by a player (or a group of more than one players), the game engine may take into account the state of the player character (or group of PCs) that is playing, but also the state of one or more PCs of offline/inactive players who are connected to the current player (or PC, or group of PCs) through the game social graph but are not necessarily involved in the game at the time.

For example, Player A with six friends on Player A's team (e.g., the friends that are listed as being in the player's mob/gang/set/army/business/crew/etc. depending on the nature of the game) may be playing the virtual game and choose to confront Player B who has 20 friends on Player B's team. In some embodiments, a player may only have first-degree friends on the player's team. In other embodiments, a player may also have second-degree and higher degree friends on the player's team. To resolve the game event, in some embodiments the game engine may total up the weapon strength of the seven members of Player A's team and the weapon strength of the 21 members of Player B's team and decide an outcome of the confrontation based on a random variable applied to a probability distribution that favors the side with the greater total. In some embodiments, all of this may be done without any other current active participants other than Player A (e.g., Player A's friends, Player, B, and Player B's friends could all be offline or inactive). In some embodiments, the friends in a player's team may see a change in their state as part of the outcome of the game event. In some embodiments, the state (assets, condition, level) of friends beyond the first degree are taken into account.

Example Game Networking Systems

A virtual game may be hosted by the game networking system 108.2, which can be accessed using any suitable connection 110 with a suitable client device 104. A player may have a game account on the game networking system 108.2, wherein the game account may contain a variety of information associated with the player (e.g., the player's personal information, financial information, purchase history, player character state, game state, etc.). In some embodiments, a player may play multiple games on the game networking system 108.2, which may maintain a single game account for the player with respect to the multiple games, or multiple individual game accounts for each game with respect to the player. In some embodiments, the game networking system 108.2 may assign a unique identifier to a player 102 of a virtual game hosted on the game networking system 108.2. The game networking system 108.2 may determine that the player 102 is accessing the virtual game by reading the user's cookies, which may be appended to HTTP requests transmitted by the client device 104, and/or by the player 102 logging onto the virtual game.

In some embodiments, the player 102 accesses a virtual game and control the game's progress via the client device 104 (e.g., by inputting commands to the game at the client device 104). The client device 104 can display the game interface, receive inputs from the player 102, transmit user inputs or other events to the game engine, and receive instructions from the game engine. The game engine can be executed on any suitable system (such as, for example, the client device 104, the social networking system 108.1, or the game networking system 108.2). For example, the client device 104 may download client components of a virtual game, which are executed locally, while a remote game server, such as the game networking system 108.2, provides backend support for the client components and may be responsible for maintaining application data of the game, processing the inputs from the player 102, updating and/or synchronizing the game state based on the game logic and each input from the player 102, and transmitting instructions to the client device 104. As another example, when the player 102 provides an input to the game through the client device 104 (such as, for example, by typing on the keyboard or clicking the mouse of the client device 104), the client components of the game may transmit the player's input to the game networking system 108.2.

In some embodiments, the player 102 accesses particular game instances of a virtual game. A game instance is a copy of a specific game play area that is created during runtime. In some embodiments, a game instance is a discrete game play area where one or more players 102 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables.

In some embodiments, a specific game instance may be associated with one or more specific players. A game instance is associated with a specific player when one or more game parameters of the game instance are associated with the specific player. For example, a game instance associated with a first player may be named “First Player's Play Area.” This game instance may be populated with the first player's PC and one or more in-game objects associated with the first player.

In some embodiments, a game instance associated with a specific player is only accessible by that specific player. For example, a first player may access a first game instance when playing a virtual game, and this first game instance may be inaccessible to all other players. In other embodiments, a game instance associated with a specific player is accessible by one or more other players, either synchronously or asynchronously with the specific player's game play. For example, a first player may be associated with a first game instance, but the first game instance may be accessed by all first-degree friends in the first player's social network.

In some embodiments, the set of in-game actions available to a specific player is different in a game instance that is associated with this player compared to a game instance that is not associated with this player. The set of in-game actions available to a specific player in a game instance associated with this player may be a subset, superset, or independent of the set of in-game actions available to this player in a game instance that is not associated with him. For example, a first player may be associated with Blackacre Farm in an online farming game, and may be able to plant crops on Blackacre Farm. If the first player accesses a game instance associated with another player, such as Whiteacre Farm, the game engine may not allow the first player to plant crops in that game instance. However, other in-game actions may be available to the first player, such as watering or fertilizing crops on Whiteacre Farm.

In some embodiments, a game engine interfaces with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a player or player character in a multiplayer game.

In some embodiments, the social graph is managed by the game networking system 108.2, which is managed by the game operator. In other embodiments, the social graph is part of a social networking system 108.1 managed by a third party (e.g., Facebook, Friendster, Myspace, Yahoo). In yet other embodiments, the player 102 has a social network on both the game networking system 108.2 and the social networking system 108.1, wherein the player 102 can have a social network on the game networking system 108.2 that is a subset, superset, or independent of the player's social network on the social networking system 108.1. In such combined systems, game network system 108.2 can maintain social graph information with edge-type attributes that indicate whether a given friend is an “in-game friend,” an “out-of-game friend,” or both. The various embodiments disclosed herein are operable when the social graph is managed by the social networking system 108.1, the game networking system 108.2, or both.

### Example Systems and Methods

Returning to FIG. 2, the Player 201 may be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration, the details of out-of-game social network 250 are described in relation to Player 201. As used herein, the terms “player” and “user” can be used interchangeably and can refer to any user in an online multiuser game system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In out-of-game social network 250, Player 201 has two first-degree friends. That is, Player 201 is directly connected to Friend 1₁ 211 and Friend 2₁ 221. In social graph 200, it is possible for individuals to be connected to other individuals through their first-degree friends (e.g., friends of friends). As described above, the number of edges in a minimum path that connects a player to another user is considered the degree of separation. For example, FIG. 2 shows that Player 201 has three second-degree friends to which Player 201 is connected via Player 201's connection to Player 201's first-degree friends. Second-degree Friend 1₂ 212 and Friend 2₂ 222 are connected to Player 201 via Player 201's first-degree Friend 1₁ 211. The limit on the depth of friend connections, or the number of degrees of separation for associations, that Player 201 is allowed is typically dictated by the restrictions and policies implemented by the social networking system 108.1.

In various embodiments, Player 201 can have Nth-degree friends connected to him through a chain of intermediary degree friends as indicated in FIG. 2. For example, Nth-degree Friend 1_{N} 219 is connected to Player 201 within in-game social network 260 via second-degree Friend 3₂ 232 and one or more other higher-degree friends.

In some embodiments, a player (or player character) has a social graph within a multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in Player 201's out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in Player 201's in-game social network 260. In some embodiments, a game engine can access in-game social network 260, out-of-game social network 250, or both.

In some embodiments, the connections in a player's in-game social network is formed both explicitly (e.g., when users “friend” each other) and implicitly (e.g., when the system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (e.g., in disintermediated interactions or the like), but that could be the case.

FIG. 9 is a diagrammatic representation of an example data flow between example components of an example system 900. One or more of the components of the example system 900 may correspond to one or more of the components of the example system 100. In some embodiments, system 900 includes a client system 930, a social networking system 920a, and a game networking system 920b. The components of system 900 can be connected to each other in any suitable configuration, using any suitable type of connection. The components may be connected directly or over any suitable network. The client system 930, the social networking system 920a, and the game networking system 920b may have one or more corresponding data stores such as the local data store 925, the social data store 945, and the game data store 965, respectively.

The client system 930 may receive and transmit data 923 to and from the game networking system 920b. This data 923 can include, for example, a web page, a message, a game input, a game display, a HTTP packet, a data request, transaction information, and other suitable data. At some other time, or at the same time, the game networking system 920b may communicate data 943, 947 (e.g., game state information, game system account information, page info, messages, data requests, updates, etc.) with other networking systems, such as the social networking system 920a (e.g., FACEBOOK, MYSPACE, etc.). The client system 930 can also receive and transmit data 927 to and from the social networking system 920a. This data can include, for example, web pages, messages, social graph information, social network displays, HTTP packets, data requests, transaction information, updates, and other suitable data.

Communication between the client system 930, the social networking system 920a, and the game networking system 920b can occur over any appropriate electronic communication medium or network using any suitable communications protocols. For example, the client system 930, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a player accesses a virtual game on the game networking system 920b, the BLOB containing the game state for the instance corresponding to the player may be transmitted to the client system 930 for use by a client-side executed object to process. In some embodiments, the client-side executable is a FLASH™-based game, which can de-serialize the game state data in the BLOB. As a player plays the game, the game logic implemented at the client system 930 maintains and modifies the various game state parameters locally. The client-side game logic may also batch game events, such as mouse clicks, and transmit these events to the game networking system 920b. Game networking system 920b may itself operate by retrieving a copy of the BLOB from a database or an intermediate memory cache (memcache) layer. The game networking system 920b can also de-serialize the BLOB to resolve the game state parameters and execute its own game logic based on the events in the batch file of events transmitted by the client to synchronize the game state on the server side. The game networking system 920b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a player selects one or more actions to perform. The web pages may be displayed in a browser client executed on the client system 930. For example, a client application downloaded to the client system 930 may operate to serve a set of web pages to a player. As another example, a virtual game may be an animated or rendered game executable as a stand-alone application or within the context of a webpage or other structured document. In some embodiments, the virtual game is implemented using ADOBE™ FLASH™-based technologies. As an example, a game may be fully or partially implemented as a SWF object that is embedded in a web page and executable by a FLASH™ media player plug-in. In some embodiments, one or more described web pages is associated with or accessed by the social networking system 920a. This disclosure contemplates using any suitable application for the retrieval and rendering of structured documents hosted by any suitable network-addressable resource or website.

Application event data of a game is any data relevant to the game (e.g., player inputs). In some embodiments, each application datum may have a name and a value, and the value of the application datum may change (e.g., be updated) at any time. When an update to an application datum occurs at the client system 930, either caused by an action of a game player or by the game logic itself, the client system 930 may need to inform the game networking system 920b of the update. For example, if the game is a farming game with a harvest mechanic (such as ZYNGA™ FARMVILLE™), an event can correspond to a player clicking on a parcel of land to harvest a crop. In such an instance, the application event data may identify an event or action (e.g., harvest) and an object in the game to which the event or action applies.

In some embodiments, one or more objects of a game may be represented as any one of an ADOBE™ FLASH™ object, MICROSOFT™ SILVERLIGHT™ object, HTML 5 object, etc. FLASH™ may manipulate vector and raster graphics, and supports bidirectional streaming of audio and video. “FLASH™” may mean the authoring environment, the player, or the application files. In some embodiments, the client system 930 may include a FLASH™ client. The FLASH™ client may be configured to receive and run FLASH™ application or game object code from any suitable networking system (such as, for example, the social networking system 920a or the game networking system 920b). In some embodiments, the FLASH™ client is run in a browser client executed on the client system 930. A player can interact with FLASH™ objects using the client system 930 and the FLASH™ client. The FLASH™ objects can represent a variety of in-game objects. Thus, the player may perform various in-game actions on various in-game objects by making various changes and updates to the associated FLASH™ objects.

In some embodiments, in-game actions are initiated by clicking or similarly interacting with a FLASH™ object that represents a particular in-game object. For example, a player can interact with a FLASH™ object to use, move, rotate, delete, attack, shoot, or harvest an in-game object. This disclosure contemplates performing any suitable in-game action by interacting with any suitable FLASH™ object. In some embodiments, when the player makes a change to a FLASH™ object representing an in-game object, the client-executed game logic may update one or more game state parameters associated with the in-game object. To ensure synchronization between the FLASH™ object shown to the player at the client system 930, the FLASH™ client may send the events that caused the game state changes to the in-game object to the game networking system 920b. However, to expedite the processing and hence the speed of the overall gaming experience, the FLASH™ client may collect a batch of some number of events or updates into a batch file. The number of events or updates may be determined by the FLASH™ client dynamically or determined by the game networking system 920b based on server loads or other factors. For example, client system 930 may send a batch file to the game networking system 920b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to player data or metadata, changes to player social connections or contacts, player inputs to the game, and events generated by the game logic. In some embodiments, each application datum has a name and a value. The value of an application datum may change at any time in response to the game play of a player or in response to the game engine (e.g., based on the game logic). In some embodiments, an application data update occurs when the value of a specific application datum is changed.

In some embodiments, when a player plays a virtual game on the client system 930, the game networking system 920b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular player and a particular virtual game. In some embodiments, while a player is not playing the virtual game, the corresponding BLOB may be stored in the database. This enables a player to stop playing the game at any time without losing the current state of the game the player is in. When a player resumes playing the game next time, game networking system 920b may retrieve the corresponding BLOB from the database to determine the most-recent values of the game-related data. In some embodiments, while a player is playing the virtual game, the game networking system 920b also loads the corresponding BLOB into a memory cache so that the game system may have faster access to the BLOB and the game-related data contained therein.

Various embodiments may operate in a wide area network environment, such as the Internet, including multiple network addressable systems. FIG. 10 is a schematic diagram showing an example network environment 1000, in which various example embodiments may operate. Network cloud 1060 generally represents one or more interconnected networks, over which the systems and hosts described herein can communicate. Network cloud 1060 may include packet-based wide area networks (such as the Internet), private networks, wireless networks, satellite networks, cellular networks, paging networks, and the like. As FIG. 10 illustrates, various embodiments may operate in a network environment 1000 comprising one or more networking systems, such as a social networking system 1020a, a game networking system 1020b, and one or more client systems 1030. The components of the social networking system 1020a and the game networking system 1020b operate analogously; as such, hereinafter they may be referred to simply as the networking system 1020. The client systems 1030 are operably connected to the network environment 1000 via a network service provider, a wireless carrier, or any other suitable means.

The networking system 1020 is a network addressable system that, in various example embodiments, comprises one or more physical servers 1022 and data stores 1024. The one or more physical servers 1022 are operably connected to computer network cloud 1060 via, by way of example, a set of routers and/or networking switches 1026. In an example embodiment, the functionality hosted by the one or more physical servers 1022 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), FLASH™, ActionScript, and the like.

The physical servers 1022 may host functionality directed to the operations of the networking system 1020. Hereinafter servers 1022 may be referred to as server 1022, although the server 1022 may include numerous servers hosting, for example, the networking system 1020, as well as other content distribution servers, data stores, and databases. Data store 1024 may store content and data relating to, and enabling, operation of, the networking system 1020 as digital data objects. A data object, in some embodiments, is an item of digital information typically stored or embodied in a data file, database, or record. Content objects may take many forms, including: text (e.g., ASCII, SGML, HTML), images (e.g., JPEG, TIF and GIF), graphics (vector-based or bitmap), audio, video (e.g., MPEG), or other multimedia, and combinations thereof. Content object data may also include executable code objects (e.g., games executable within a browser window or frame), podcasts, etc.

Logically, data store 1024 corresponds to one or more of a variety of separate and integrated databases, such as relational databases and object-oriented databases, that maintain information as an integrated collection of logically related records or files stored on one or more physical systems. Structurally, data store 1024 may generally include one or more of a large class of data storage and management systems. In some embodiments, data store 1024 may be implemented by any suitable physical system(s) including components, such as one or more database servers, mass storage media, media library systems, storage area networks, data storage clouds, and the like. In one example embodiment, data store 1024 includes one or more servers, databases (e.g., MySQL), and/or data warehouses. Data store 1024 may include data associated with different networking system 1020 users and/or client systems 1030.

The client system 1030 is generally a computer or computing device including functionality for communicating (e.g., remotely) over a computer network. The client system 1030 may be a desktop computer, laptop computer, PDA, in- or out-of-car navigation system, smart phone or other cellular or mobile phone, or mobile gaming device, among other suitable computing devices. Client system 1030 may execute one or more client applications, such as a Web browser.

When a user at a client system 1030 desires to view a particular webpage (hereinafter also referred to as target structured document) hosted by the networking system 1020, the user's web browser, or other document rendering engine or suitable client application, formulates and transmits a request to the networking system 1020. The request generally includes a URL or other document identifier as well as metadata or other information. By way of example, the request may include information identifying the user, a timestamp identifying when the request was transmitted, and/or location information identifying a geographic location of the user's client system 1030 or a logical network location of the user's client system 1030.

Although the example network environment 1000 described above and illustrated in FIG. 10 is described with respect to the social networking system 1020a and the game networking system 1020b, this disclosure encompasses any suitable network environment using any suitable systems. For example, a network environment may include online media systems, online reviewing systems, online search engines, online advertising systems, or any combination of two or more such systems.

FIG. 11 is a block diagram illustrating an example computing system architecture, which may be used to implement a server 1022 or a client system 1030. In one embodiment, the hardware system 1100 comprises a processor 1102, a cache memory 1104, and one or more executable modules and drivers, stored on a tangible computer-readable storage medium, directed to the functions described herein. Additionally, the hardware system 1100 may include a high performance input/output (I/O) bus 1106 and a standard I/O bus 1108. A host bridge 1110 may couple the processor 1102 to the high performance I/O bus 1106, whereas the I/O bus bridge 1112 couples the two buses 1106 and 1108 to each other. A system memory 1114 and one or more network/communication interfaces 1116 may couple to the bus 1106. The hardware system 1100 may further include video memory (not shown) and a display device coupled to the video memory. Mass storage 1118 and I/O ports 1120 may couple to the bus 1108. The hardware system 1100 may optionally include a keyboard, a pointing device, and a display device (not shown) coupled to the bus 1108. Collectively, these elements are intended to represent a broad category of computer hardware systems.

The elements of the hardware system 1100 are described in greater detail below. In particular, the network interface 1116 provides communication between the hardware system 1100 and any of a wide range of networks, such as an Ethernet (e.g., IEEE 802.3) network, a backplane, etc. The mass storage 1118 provides permanent storage for the data and programming instructions to perform the above-described functions implemented in servers 1022 of FIG. 10, whereas system memory 1114 (e.g., DRAM) provides temporary storage for the data and programming instructions when executed by the processor 1102. I/O ports 1120 are one or more serial and/or parallel communication ports that provide communication between additional peripheral devices, which may be coupled to the hardware system 1100.

The hardware system 1100 may include a variety of system architectures and various components of the hardware system 1100 may be rearranged. For example, cache memory 1104 may be on-chip with the processor 1102. Alternatively, the cache memory 1104 and the processor 1102 may be packed together as a “processor module,” with processor 1102 being referred to as the “processor core.” Furthermore, certain embodiments of the present disclosure may neither require nor include all of the above components. For example, the peripheral devices shown coupled to the standard I/O bus 1108 may couple to the high performance I/O bus 1106. In addition, in some embodiments, only a single bus may exist, with the components of the hardware system 1100 being coupled to the single bus. Furthermore, the hardware system 1100 may include additional components, such as additional processors, storage devices, or memories.

An operating system manages and controls the operation of the hardware system 1100, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related virtual objects (such as stores and restaurants), the embodiments can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method, comprising:
receiving, by a client device, a request to access a game through a game user interface on the client device;
identifying that the client device is unable to communicate with a game server associated with the game;
in response to identifying that the client device is unable to communicate with the game server, generating, by the client device, an advertisement using one or more cached objects stored on the client device and received from the game server when the client device was previously in communication with the game server; and
providing access to the game including providing the advertisement in the game user interface.

2. The computer-implemented method of claim 1, wherein generating the advertisement includes generating the advertisement in accordance with user information associated with a player of the game user interface, the user information stored on the client device and received from the game server when the client device was previously in communication with the game server.

3. The computer-implemented method of claim 2, further comprising:
receiving, from the game server, an update to the user information when the client device is in communication with the game server.

4. The computer-implemented method of claim 2, wherein the user information includes information relating to aesthetic features of the one or more cached objects.

5. The computer-implemented method of claim 2, wherein the user information includes information relating to demographics associated with the player.

6. The computer-implemented method of claim 2, wherein the user information includes information relating to prior activities of the player.

7. The computer-implemented method of claim 1, further comprising:
receiving, from the game server, an update to the one or more cached objects when the client device is in communication with the game server.

8. A machine-readable storage medium storing instructions which, when executed by one or more processors, cause the one or more processors to perform operations comprising the method of claim 1.

9. A device, comprising:
a hardware-implemented user input module configured to receive a request to access a game through a game user interface on the device;
a hardware-implemented network detection module configured to identify that the device is unable to communicate with a game server associated with the game;
a hardware-implemented advertisement generation module configured to, in response to identifying that the device is unable to communicate with the game server, generate an advertisement using one or more cached objects stored on the device and received from the game server when the device was previously in communication with the game server; and
a hardware-implemented display module configured to provide access to the game including providing the advertisement in the game user interface.

10. The device of claim 9, wherein the hardware-implemented advertisement generation module is further configured to generate the advertisement in accordance with user information associated with a player of the game user interface, the user information stored on the device and received from the game server when the device was previously in communication with the game server.

11. The device of claim 10, wherein the hardware-implemented advertisement generation module is further configured to receive, from the game server, an update to the user information when the device is in communication with the game server.

12. The device of claim 10, wherein the user information includes information relating to aesthetic features of the one or more cached objects.

13. The device of claim 10, wherein the user information includes information relating to demographics associated with the player.

14. The device of claim 10, wherein the user information includes information relating to prior activities of the player.

15. The device of claim 9, wherein the hardware-implemented advertisement generation module is further configured to receive, from the game server, an update to the one or more cached objects when the device is in communication with the game server.

16. A computer-implemented method, comprising
receiving, by a client device, a request to purchase a game asset of a game through a game user interface on the client device;
identifying that the client device is unable to communicate with a game server associated with the game;
in response to identifying that the client device is unable to communicate with the game server, accessing, by the client device, a reliability score stored on the client device and received from the game server when the client device was previously in communication with the game server, the reliability score indicating a likelihood of receiving a payment in exchange for the game asset; and
providing the game asset in the game user interface if the reliability score is greater than or equal to a minimum reliability score.

17. The computer-implemented method of claim 16, further comprising:
receiving, from the game server, an update to the reliability score when the client device is in communication with the game server.

18. The computer-implemented method of claim 16, wherein the reliability score is calculated based on an amount of game assets a player of the game user interface has previously purchased.

19. The computer-implemented method of claim 16, wherein the reliability score is calculated based on a number of other players who communicate with a player of the game user interface.

20. The computer-implemented method of claim 16, further comprising:
determining the reliability score is less than the minimum reliability score; and
preventing the purchase of the game asset.

21. The computer-implemented method of claim 16, wherein the reliability score is calculated based on player activity in one or more other games associated with the game server.

22. The computer-implemented method of claim 16, wherein the reliability score is calculated based a frequency at which a player of the game user interface plays the game.

23. A machine-readable storage medium storing instructions which, when executed by one or more processors, cause the one or more processors to perform operations comprising the method of claim 16.

24. A device, comprising:
a hardware-implemented user input module configured to receive a request to purchase a game asset of a game through a game user interface on the device;
a hardware-implemented network detection module configured to identify that the device is unable to communicate with a game server associated with the game;
a hardware-implemented user reliability module configured to, in response to identifying that the device is unable to communicate with the game server, access a reliability score stored on the device and received from the game server when the device was previously in communication with the game server, the reliability score indicating a likelihood of receiving a payment in exchange for the game asset; and
a hardware-implemented display module configured to provide the game asset in the game user interface if the reliability score is greater than or equal to a minimum reliability score.

25. The device of claim 24, wherein the hardware-implemented user reliability module is further configured to receive, from the game server, an update to the reliability score when the device is in communication with the game server.

26. The device of claim 24, wherein the reliability score is calculated based on an amount of game assets a player of the game user interface has previously purchased.

27. The device of claim 24, wherein the reliability score is calculated based on a number of other players who communicate with a player of the game user interface.

28. The device of claim 24, wherein the hardware-implemented user reliability module is further configured to determine the reliability score is less than the minimum reliability score and prevent the purchase of the game asset.

29. The device of claim 24, wherein the reliability score is calculated based on player activity in one or more other games associated with the game server.

30. The device of claim 24, wherein the reliability score is calculated based a frequency at which a player of the game user interface plays the game.
